(19) United States
(12) Patent Application Publication
(10) Pub. No.: US 2002/0154873 A1
(43) Pub. Date: Oct. 24, 2002

(54) Core enclosures and methods for making the same

(75) Inventor: Jim J. Sheu, Dunwoody, GA (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Fiber-Line, Inc.

(21) Appl. No.: 09/770,860

(22) Filed: Jan. 26, 2001

(51) Int. Cl. G02B 6/44

(52) U.S. Cl. 385/114; 385/100; 385/141

(57) ABSTRACT

Core enclosures suitable for use in a fiber optic cables and having water-blocking capabilities as well as methods for forming such core enclosures are disclosed. The core enclosures include a mixture of a superabsorbent polymer and a plastisol, the plastisol comprising a thermoplastic resin and a plasticizer. Also disclosed are fiber optic cables which include these core enclosures. The core enclosures protect optical fibers from damage caused by water by blocking and retaining water that has entered into a fiber optic cable and by preventing water from penetrated through the core enclosure to optical fibers enclosed within.

### BACKGROUND OF THE INVENTION

Optical fibers are an extremely important transmission medium for carrying telecommunications signals. Optical fibers have several advantages over conventional copper cables, in particular they can accommodate large bandwidth transmissions and their small size makes them ideal for use in a wide variety of congested areas, from densely-populated urban neighborhoods to narrowly confined building ducts. In actual usage, optical fibers are not deployed by themselves, but rather several or even hundreds of them are placed together within a fiber optic cable.

While optical fibers provide many benefits, they also have the drawback that they are highly susceptible to damage by water or moisture, especially in environments where the temperature approaches or falls below 0° C. For example, when wetted by water or moisture, stress corrosion fractures can occur in optical fibers at static stresses that are well below the optical fiber's actual tensile strength. Even worse is the damage that may result when water penetrates into the fiber optic cable that houses the optical fibers and, moving longitudinally through the cable interior, comes to a splicing junction or closure where two separate lengths of fiber optic cables are joined together. The result may be a disruption of the connection, potentially causing a communication loss along the entire length of the cable. Thus there has been a continuing effort to develop fiber optic cables that are well-protected against the possibility of transmission degradation caused by the presence of water or moisture within the cable.

Conventionally, fiber optic cables are protected against water damage by the use of multiple layers of water-resistant materials. Thus an outer jacket layer, commonly made from a lightweight water-resistant polymer like polyethylene, would form the exterior of the cable, while one or more layers of water-resistant polymeric and metallic material would be found inside. While these multiple layers of water-resistant materials often provide a level of protection against water damage, this level of protection is insufficient for many fiber optic cable applications. Moreover, once water penetrates into the fiber optic cable, the layers do nothing to prevent the water from moving longitudinally through the cable interior.

Accordingly, in response to the problems noted above, hydrophobic water-blocking materials have been incorporated into fiber optic cables to provide additional protection. These water-blocking materials are typically in the form of gels, greases or pastes that are applied interstitially within the fiber optic cable. These pastes and gels, typically referred to as flooding and filling compounds depending on their particular use, provide excellent water-blocking performance. They are also space-efficient because they are inserted into the interstices of a fiber optic cable that would otherwise be unoccupied. However, these flooding and filling compounds are awkward and inconvenient to work with because they are sticky and messy and additionally require the use of a solvent to remove the compounds from the surface of the fiber optic cable at termination points in order to splice the fiber optic cable or join two separate lengths of fiber optic cable together. On account of this, those in the field have long sought alternative materials to gel or paste water-blocking materials.

An alternative to gel or paste water-blocking materials are the longitudinally-extending, water-absorbing tapes, yarns or fibers. Also suitable and effective as materials for absorbing and retaining water are the semi-gel compositions described in U.S. Pat. No. 5,817,713. But while these materials are effective at absorbing water, they are often expensive and also space-inefficient because the interior of the fiber optic cable must be specifically designed to leave space to accommodate them, space that could otherwise hold additional optical fibers. While an inefficient space usage is undesirable for all types of core enclosures, it is especially undesirable in a relatively new core enclosure design called a microsheath. Microsheaths, which are discussed in greater detail below, are a particularly desirable core enclosure design because they can hold a much larger number of optical fibers than conventional cable constructions while still maintaining a relatively compact size.

Thus because the use of water blocking or water-absorbing materials consumes scarce space inside both the fiber optic cable and the core enclosure as well as increases cable production time, there is a continuing need to develop a core enclosure that is small and compact but does not require water-blocking additives or additional water-blocking components.

### BRIEF SUMMARY OF THE INVENTION

The present invention includes a core enclosure that comprises a mixture of a superabsorbent polymer and a plastisol, the plastisol comprising a thermoplastic resin and a plasticizer, wherein the core enclosure has water-blocking capabilities.

The present invention also includes a fiber optic cable comprising a core enclosure that is disposed around a fiber bundle having at least one optical fiber, wherein the core enclosure comprises a water-blocking mixture of a superabsorbent polymer (“SAP”) in a plastisol, and the plastisol comprises a thermoplastic resin and a plasticizer

There is also provided a method for the manufacture of a fiber optic bundle comprising at least one optical fiber enclosed by a core enclosure, comprising forming a core enclosure around the at least one optical fiber, the core enclosure being formed from a water-blocking composition comprising a mixture of a SAP and a plastisol, the plastisol comprising a thermoplastic resin and a plasticizer.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention there is shown in the drawings, embodiments which are presently preferred. It should be understood, however, that the invention is not limited to the precise arrangements and instrumentalities shown in the drawings:

FIG. 1 is a perspective view of a rectangular core enclosure prepared according to the present invention;

FIG. 1A is a perspective view of a round tubular core enclosure prepared according to the present invention;

FIG. 2 is a cross-sectional view along line 2-2 of the core enclosure of FIG. 1;

FIG. 2A is a cross-sectional view along line 2A-2A of the core enclosure of FIG. 1A;

FIG. 3 is a partially broken-away perspective view of an optical fiber ribbon;

FIG. 4 is a transverse cross-sectional view of a stack of optical fiber ribbons;

FIG. 5 is an end sectional view of a core enclosure enclosing multiple optical fiber bundles;

FIG. 6 is an end sectional view of a core enclosure enclosing multiple optical fiber ribbons;

FIG. 7 is a perspective view of a loose-tube fiber optic cable;

FIG. 8 is a perspective view of a central-core fiber optic cable;

FIG. 9 is a perspective view of a core enclosure; FIG. 9A is a partially enlarged sectional view of a portion of FIG. 9 according to the present invention;

FIG. 10 is a perspective view of a core enclosure; FIG. 10A is a partially enlarged sectional view of FIG. 10 according to the present invention; and

FIG. 11 is an end sectional view of a central-core fiber optic cable.

### DETAILED DESCRIPTION OF THE INVENTION

The following describes preferred embodiments of the present invention, which provides a core enclosure for use in fiber optic cables that absorbs and retains large quantities of water and is also space-efficient, relatively inexpensive and convenient to work with both during manufacture of the fiber optic cables and installation of the cables in the field.

By “optical fiber” it is meant any fiber capable of transmitting data or similar telecommunications signals, which may be either coated with one or more coating layers or uncoated. A particularly preferred coating layer is one that serves as a color identification layer to assist telecommunications service personnel to distinguish between several different otherwise identical optical fibers.

By “core enclosure” it is meant to include microsheaths, loose tubes, uni-tubes, slotted core tubes, buffer tubes and all other optical fiber-enclosing tubes and enclosures.

By “mixture” it is meant any combination of two or more substances, in the form of, for example without intending to be limited, a heterogeneous mixture, a suspension, a solution, a sol, a gel, a plastisol, a semi-gel dispersion, a dispersion or an emulsion.

By “absorption” and “absorbing” it is meant both the process of absorption, in which a liquid is taken up by a solid substances and penetrates into the solid substance, as well as the physical process of adsorption, which is the adhesion of a liquid to the surface of a solid.

The core enclosures of the present invention are formed from a specially-formulated water-blocking composition including a mixture of superabsorbent polymers and a plastisol. These core enclosures solve the long-standing need for an inexpensive and convenient material that protects optical fibers , are space-efficient, and allows fiber optic cables to be easily and conveniently manufactured and installed. Upon first being contacted by water the core enclosures absorb and retain the water and then further block additional amounts of water from penetrating through the core enclosures to contact the optical fibers therein. The primary chemical components of these core enclosures are a superabsorbent polymer (SAP), capable of blocking water and absorbing and a quantity of water many times its own weight, and a plastisol, which includes a thermoplastic resin and a plasticizer.

The core enclosures of the present invention provide this versatile set of benefits because they are capable of performing several independent functions in a fiber optic cable. First, the core enclosures serve a structural function by holding and containing the optical fibers. Second, the core enclosures act to both block and absorb water, because their chemical formulation not only prevents the further ingress of water into the core of the cable, but also absorbs and retains water that has entered the fiber optic cable. Third, the core enclosures can be easily opened and the inside of the core enclosure accessed without the use of special tools or equipment.

No prior art reference discloses a core enclosure suitable for use in a fiber optic cable that serves as both a structural element and absorbs water that has penetrated into the cable as well as blocks water from coming into contact with the optical fibers. Rather, in prior art fiber optic cables a polymer jacket or tubular structural member is necessary to house and contain the optical fibers while separate water-absorbing and water-blocking yarns, fibers, tapes, gels or paste compositions are added as further protection against water damage. Accordingly, by the present invention it is no longer necessary to add these separate water-blocking and water-absorbing components to a fiber optic cable.

Not only do these core enclosures perform several different functions, but they are extremely versatile and may be configured for use in a fiber optic cable in a variety of ways. The core enclosures may enclose only a single optical fiber, or several optical fibers in a bundle or even several bundles of optical fibers. Although they are preferably used within a fiber optic cable, these core enclosures may also be used by themselves as a fiber optic cable, without additional fiber optic cable components.

The ingredients of the water-blocking core enclosure mixture will now be discussed in detail. Subsequently, the physical structure of the microstructure and its use along with optical fibers in a fiber optic cable will be discussed. Finally, processes for forming the core enclosure will be discussed.

The water-blocking core enclosure compositions of the present invention are mixtures of one or more SAPs and a plastisol. The SAPs according to the present invention are hydrophilic polymers capable of absorbing large quantities of water and subsequently blocking further amounts of water from penetrating through the core enclosure. Without being limited by theory, it is believed that the mechanism by which SAPs absorb water begins as water or another aqueous liquid wets the surface of a SAP and is physically distributed into and throughout the polymeric chain network of the SAP. Located on the polymer carbon chains of the SAP are water-binding groups of one or more atoms capable of forming hydrogen bonds with the hydrogen atoms of a water molecule. A carboxylic acid moiety is an example of a water-binding group. As water is distributed into the polymer chain network of the SAP, individual water molecules form hydrogen bonds with the water binding groups to produce charged ionic groups. These charged ionic groups then repel each other causing the polymer network to expand and unfold and allowing the SAP to be capable of absorbing yet more water or other aqueous liquids.

The SAP itself may be in the form of a fiber or a particle. When the SAP is in the form of a particle, preferably the average particle size is from about 1 to about 500 microns, more preferably from about 1 to about 100 microns, as measured by a standard sieve or other suitable instrument or method for accurately measuring particle size. When the SAP is in the form of a fiber, the cut length is preferably less than 6 mm. The fiber may also, in certain applications, be chopped or pulverized into a fine form. The particle size may be smaller or larger depending upon the application. Suitable SAPs include any salts of polyacrylate-based polymers, such as sodium, potassium and ammonium salts. The preferred SAPs for use in the present invention include homopolymers and copolymers of sodium and potassium polyacrylates. Other useful polymers include starch-grafted sodium polyacrylate and partial sodium salt of polypropenoic acid. Preferably the SAP are at least partially cross-linked. Also suitable are copolymers of polyacrylamide and polyacrylate as well as hydrophilic polyalkyl oxides such as certain polyethylene oxides and polypropylene glycols

The core enclosure formulations of the present invention also include a plastisol, which preferably includes a thermoplastic resin and a plasticizer. The thermoplastic resin is preferably a polyvinyl chloride, a copolymer of a polyvinyl chloride, or a mixture thereof. Also suitable are other polyolefins and/or polyvinyl thermoplastics, such as homopolymers and copolymers of the following: polypropylene, polyvinylidene chloride, polyethylene or mixtures of one or more of these thermoplastic resins.

Any plasticizer that is compatible with the aforementioned thermoplastic resins may be used in the present plastisols. Preferably, the plasticizer is selected from the group consisting of esters of phthalic acid, esters of adipic acid, esters of sebacic acid, phosphate esters, complex polymeric adipates, esters of isobutyric acid, polyesters such as those based on propylene glycol and adipic acid, monomeric esters such as trimellitates, acrylate monomers such as triethlylene glycol dimethacrylate and mixtures thereof.

Suitable esters of phthalic acid such as di-2-ethylhexyl phthalate (DOP), butyl octyl phthalate, dihexyl phthalates, diethyl phthalates (DEP), dimethyl phthalates (DMP), dibutyl phthalates (DBP), diisononyl phthalate, dioctyl terephthalate (DOTP), and alcohol phthalates; esters of adipic acid such as dioctyl adipate (DOA), phosphate esters such as tricresyl phosphate, octyldiphenyl phosphate and trixylenyl phosphate, triphenyl phosphate, trioctyl phosphate, as well as, dioctyl sebacate, trioctyl trimellitate, and triisooctyl trimellitate; suitable commercial forms of many of the adipates and phthalates are specifically available from the Exxon-Mobile Company, Eastman Chemical Company, and the Velsicol Chemical Corporation. Also suitable are complex polymeric adipates such as hexanedioic acid, polymer with butanediol (or 1,3-butanediol), 2-ethylhexyl ester; hexanedioc acid, polymer with 1,3 butanediol, hexadecanoate; hexanedioc acid, polymer with 1,2-propanediol, 2-thylhexyl ester; and fatty acid glycol adipates; suitable examples of these latter adipic esters are sold under the trade names ADMEX® 6187, ADMEX® 69851, AMDEX® 429, AMDEX® 412, AMDEX® 409 from the Vesicol Chemical Corporation. Also suitable is a proprietary adipate, dibasic acid, gycol alcohol ester sold under the trade name AMDEX® 6994. Suitable phthalates are available from the BASF Corporation under the tradenames PALATINOL® 9P (a dinonyl phthalate), PALATINOL® 79P, PALATINOL® 11-9P-I, and PALATINOL®) 711 P. A suitable trimellitate plasticizer is PALATINOL® 79TM-I.

Esters of isobutyric acid include isobutyl isobutyrate and 2,2,4-trimethyl-1,3-pentanediol diisobutyrate, the latter of which is sold by the Eastman Chemical Company under the trade names “TEXANOL® Isobutyrate” (TXIB) and KODAFLEX TXIB®.

Blends or mixtures of these plasticizers as well as the use of other similar plasticizers are also acceptable. Preferably, the plasticizer used is DOP or DOA. A particularly preferred plasticizer blend is the mixture of bis(2-ethylhexyl)-terephthalate, 2,2,4-trimethyl-1,3-pentanediol diisobutyrate; when this blend is used, it is preferred that the water-blocking composition should contain up to about 50% of bis(2-ethylhexyl)-terephthalate, and up to about 50% of 2,2,4-trimethyl-1,3-pentanediol diisobutyrate.

The liquid plastisol may be purchased commercially as a plastisol formulation or independently synthesized.

The core enclosures of the present invention will preferably include from about 1% to about 60%, preferably from about 5% to about 55% of one or more SAPs, from about 10% to about 90%, preferably from about 10% to about 40% of the thermoplastic resin(s), and from about 10% to about 70%, preferably from about 20% to about 40% of the plasticizer. When a core enclosure comprises SAP near the upper end of the concentration range, in order to ensure maximum water-blocking capability, it is important to select at least one low viscosity plasticizer in the core enclosure composition. Examples of low viscosity plasticizers are DOA, DMP, DEP, DBP and TXIB

The core enclosures may also include additional ingredients besides the SAP and plastisol, such as secondary plasticizers, flame retardants, stabilizers, fillers, colorants, viscosity modifiers, foaming agents and combinations of these additives. Suitable secondary plasticizers include aliphatic hydrocarbons, aromatic hydrocarbons and chlorinated hydrocarbons as flame retardants. Suitable secondary plasticizers may also include, for example, those listed above, epoxidized soya and linseed oils, and/or other known plasticizers. Stabilizers should be capable of neutralizing hydrogen chloride, a decomposition product of PVC. Suitable stabilizers include, for example, mixed metal salts, such as barium-cadmium-zinc-based, barium-cadmium-based and cadmium-zinc-based stabilizers and organic tin stabilizers. Preferably, the mixed metal salt stabilizers are used. Light and UV stabilizers, such as 2-hydrobenzophenones, aryl-substituted acrylates and p-aminobenzoates can also be provided. Particularly preferred as additives are the flame retardants (particularly chlorinated hydrocarbons) and the secondary plasticizers. The core enclosure composition will contain no more than about 40% of these additional ingredients.

After having selected a formulation for the core enclosure composition, the ingredients are then thoroughly mixed together to form a homogeneous composition. First, the thermoplastic resin powder is dispersed in a liquid plasticizer to form a plastisol. This mixing preferably takes place in a dispersator or other high-speed mixer. Then the SAP powder is mixed in with the plastisol, preferably in a ribbon blender to insure thorough mixing. It will be understood by those of ordinary skill in the art that this process could be modified or adjusted depending on the particular needs of the manufacturer so long as these basic ingredients were thoroughly mixed in each other.

Having described the chemical composition of the core enclosure, the physical structure of the core enclosure and its placement in a fiber optic cable will now be discussed. Other fiber optic cable components are discussed below.

The core enclosures of the present invention are longitudinally-extending members that are typically tubular or rectangular in shape and are disposed around a bundle of optical fibers and will preferably be found inside a fiber optic cable as one of the components of the cable-although these core enclosures may also be used by themselves as a fiber optic cable. As used herein, “core enclosure” encompasses many different types of optical fiber-enclosures that are present in a variety of different configurations but generally are in the form of a thin layer of polymeric tube material enclosed around a bundle of optical fibers or ribbons. Examples of core enclosures are microsheaths, loose tubes, uni-tubes, slotted core tubes, buffer tubes as well as other optical fiber-enclosing tubes and enclosures.

A bundle, in accord with the use of the term in this invention, includes at least one optical fiber. It is preferable that the bundles used in the present invention be composed of several optical fibers because as the volume of telecommunications traffic continues to rapidly increase rapidly there is an increasing demand for the higher bandwidth provided by grouping large numbers of optical fibers together.

Bundles having more than optical fiber are formed by bringing together several optical fibers and arranging them substantially longitudinally parallel with one another and in close proximity to and/or touching one another. A bundle may optionally be coated, impregnated and/or extruded with a layer of the core enclosure composition. The optical fibers in the bundle may be held together with any polymeric matrix bonding material that one of skill in the art would recognize as being compatible and suitable as a bonding material to hold together optical fibers. A particularly preferred polymeric matrix bonding material is an ultraviolet-curable matrix bonding material discussed in greater detail below. The water-blocking core enclosure composition may also be used as the polymeric matrix bonding material.

Each core enclosure prepared according to the present invention will enclose at least one bundle, but may optionally contain multiple bundles. When multiple bundles are brought together it is preferred that each bundle be coated or enclosed within a core enclosure. Thus, bundles enclosed in a core enclosure can be “nested” within fiber optic cables, i.e. a core enclosure may enclose several bundles, wherein each individual bundle is itself enclosed in a core enclosure. Bringing together several bundles offers the advantage of increased bandwidth and the ability to handle greater volumes of telecommunications traffic. In addition, because the core enclosures absorb water and block the ingress of water it is not necessary to include other water-blocking and water-absorbing components, thus allowing for more optical fibers to be more densely and efficiently packed within the fiber optic cable.

The use of multiple bundles is illustrated in FIG. 5. Optical fibers 18 are formed into bundles which comprise seven optical fibers in the example shown. Each bundle is enclosed in either a core enclosure or coating layer 70 that coats the optical fibers 18 and serves to hold them together. This set of modules is itself in contact with and enclosed by a larger core enclosure 75.

When multiple bundles (being either coated or uncoated) are incorporated into a single core enclosure, it is preferable that the optical fibers as well as optionally the optical fiber bundles are desirably color-coded or marked with some other indicia for identification purposes. Accordingly, it is preferred for the core enclosures be translucent or no more than partially opaque, so that the identifying colors or markings of the optical fiber ribbons and optical fibers can be seen through the core enclosure. Alternatively or in addition, different core enclosures may be color-coded or marked with identifying indicia, or the like for identification purposes. Preferably, the core enclosure is also formulated so that it can be easily torn and the optical fibers inside accessed. In accordance with one example of this easily torn embodiment the core enclosure has a thickness of less than about 0.06 cm.

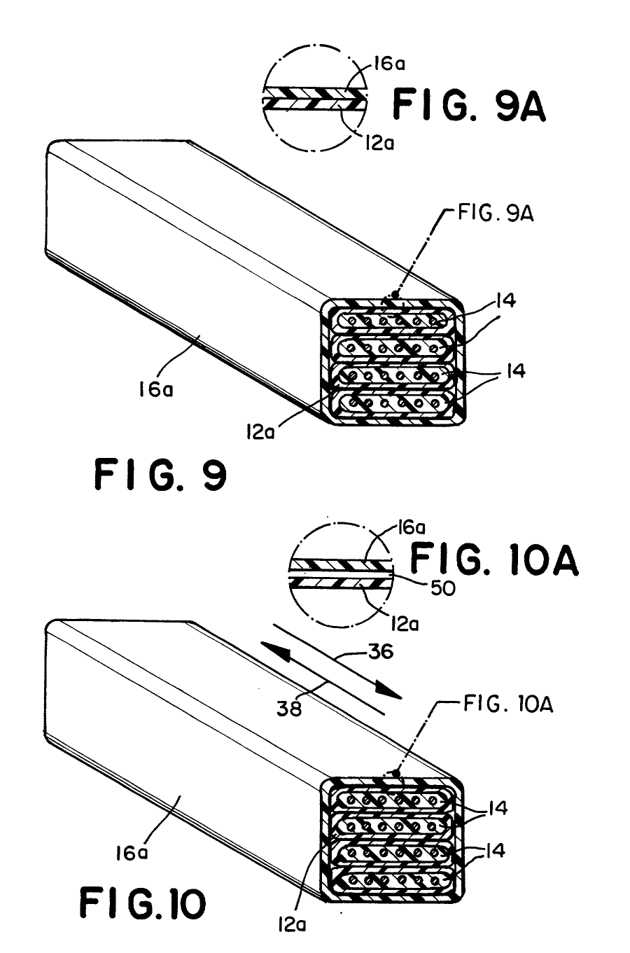

When a core enclosure is formed on a bundle by either dip-coating or spray-coating processes, then the core enclosure will typically not be adhered to the exterior of the bundle and thus the bundle will be capable of moving longitudinally relative to the bundle or bundles. However, dip-coating or spray-coating processes, as well as extrusion processes may also be used to produce core enclosures that are adhered to the exterior of the bundle by establishing a close or tight fit between the bundle and the core enclosure. Additionally, the core enclosure may be bonded to the exterior surface of the bundle or bundles by the use of any of the bonding materials that are commonly-known to those skilled in the art and are compatible with the polymeric resins and optical fiber materials discussed herein. FIG. 9 shows a perspective view of bundles of optical fibers in the form of a stack 12a of optical fiber ribbons 14 inside a core enclosure 16a formed by extrusion. In the part of the perspective view shown as an enlarged view it can be seen that a tight fit has been established between the stack of optical fiber ribbons 12a and the core enclosure 16a, so that the core enclosure will be unable to move relative to the bundles. Optionally, a bonding material may be applied between the stack of optical fiber ribbons 12a and the core enclosure 16a to ensure that no such movement is possible.

Alternatively, when the core enclosure is formed by extrusion, sufficient space may be left between the core enclosure and the bundle so that the core enclosure may be able to move longitudinally relative to the bundle or bundles. FIG. 10 shows a perspective view of bundles of optical fibers, the bundles being in the form of a stack 12a of optical fiber ribbons 14 inside a core enclosure 16a formed by extrusion. Optical fiber ribbons are discussed in greater detail below. In the part of the perspective view shown as an enlarged view it can be seen that a space 50 is present between the stack of optical fiber ribbons 12a and the core enclosure 16a. As a result, the core enclosure 50 is capable of moving relative to the stack 12a in the directions indicated by arrows 36 and 38.

A lubricant may optionally be applied between the bundle and the core enclosure to facilitate such movement, particularly because the space 50 between the stack 12a and the core enclosure 16a may be significantly narrowed in certain places, as a result of inconsistencies in manufacturing, as to impede the smooth movement of the core enclosure. While optional, lubricants are especially preferred where relative motion is desired and a particularly tight fit has been established between the core enclosure and the bundle. Lubricants are also used to reduce the adhesion and bonding among the optical fibers and also among the optical fiber ribbons. Suitable lubricants, as well as methods for applying such lubricants, are discussed in greater detail below.

One particularly convenient way of combining multiple optical fiber bundles is through the use of optical fiber ribbons. Optical fiber ribbons are arrays of multiple optical fibers that are formed together either by UV-curable polymers, melt processable polymers, heat curable polymers or other suitable adhesive substances. Optical fiber ribbons are particularly preferred because they offer the means to conveniently and rigorously assemble large numbers of optical fibers together in a small space.

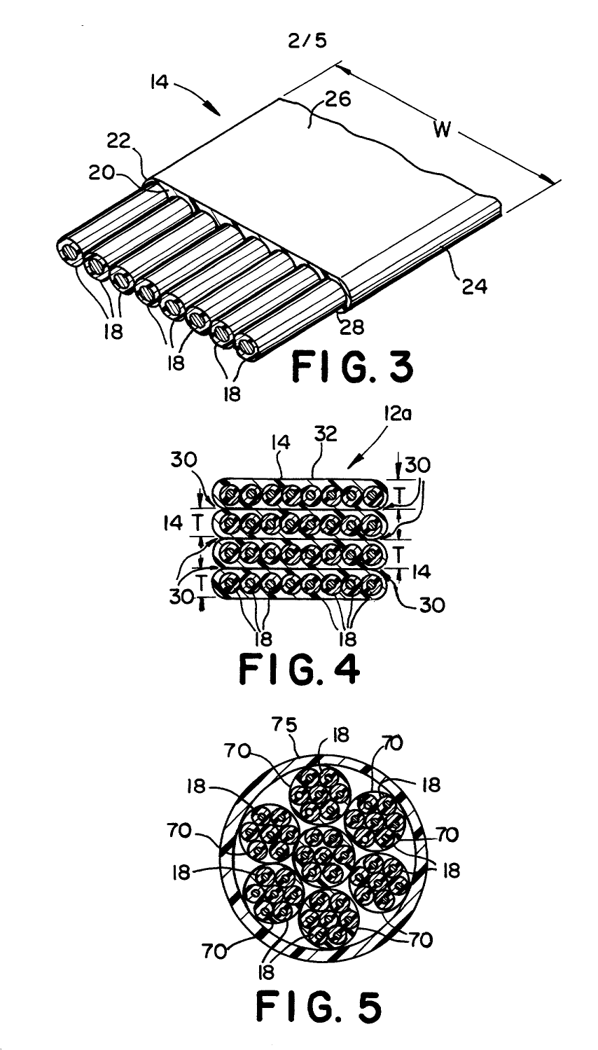

In their most common form, as shown in FIG. 3, an optical fiber ribbon 14 is a generally planar array of optical fibers 18 (as shown here the optical fibers 18 include one or more coating layers, but these coating layers are optional). The optical fibers are held in a uniformly spaced, generally longitudinally parallel arrangement, preferably by a polymeric matrix bonding material 20, and having a thickness T (as shown in FIG. 4) defined by the distance between a pair of opposite surfaces 26, 28 that extend longitudinally and transversely between the longitudinally extending opposite edges 22, 24. While eight fibers are shown together in the ribbon of FIG. 3, such ribbons may frequently contain either less or significantly more optical fibers. As can be seen in FIG. 3, the polymeric matrix bonding material 20 holds together adjacent optical fibers and fills the interstices between the optical fibers 18.

The polymeric matrix bonding material 40 may be any suitable bonding material meeting the criteria noted above, a typical bonding material is an ultraviolet (UV)-curable matrix bonding material that includes a resin, a diluent and a photoinitiator. Exemplary UV-curable materials include a diethylenic-terminated resin synthesized from a reaction of hydroxy-terminated alkyl acrylate with the reaction product of a polyester of polyethyl polyol having a molecular weight of about 1,000 to about 6,000 with an aliphatic or aromatic diisocyanate, or diethylenic-terminated resin synthesized from the reaction of glycidyl acrylate with a carboxylic-terminated polymer or polyether of molecular weight of about 1,000 to about 6,000. The diluent may include one or more monofunctional or polyfunctional acrylic acid esters having a molecular weight of about 100 to about 1,000 or N-vinylpyrrolidinone. For the photoinitiator, the composition may include one or more ketonic compounds such as diethoxyacetophenone, acetophenone, benzophenone, benzoin, anthraquinone, and benzil dimethyl ketal.

In a typical composition, the bonding matrix may include from about 50% to about 90% of resin, from about 5% to about 40% of diluents, and from about 1% to about 10% of photoinitiators.

Other suitable bonding materials for matrix 20 include homopolymers and copolymers of methacrylate, an ultraviolet-curable epoxide or an unsaturated polyester.

Optical fiber ribbons are discussed in greater detail in U.S. Pat. No. 4,900,126.

In order to maximize the optical fiber density and thus increase telecommunications bandwidth, it is preferred that these optical fiber ribbons form a “stack” of two or more optical fiber ribbons to increase the density of the optical fibers. FIG. 4 illustrates a stack 12a of optical fiber ribbons 14. The generally flat, longitudinally-extending sides 26, 28 of each optical fiber ribbon 14 may be coated with a lubricant at junctions 30, where each of the optical fiber ribbons contact each other. The lubricant coating performs two separate functions: it “bonds” adjacent ribbons together as a result of the surface tension of the lubricant, while also encouraging longitudinal movement of the ribbons relative to each other or the core enclosure.

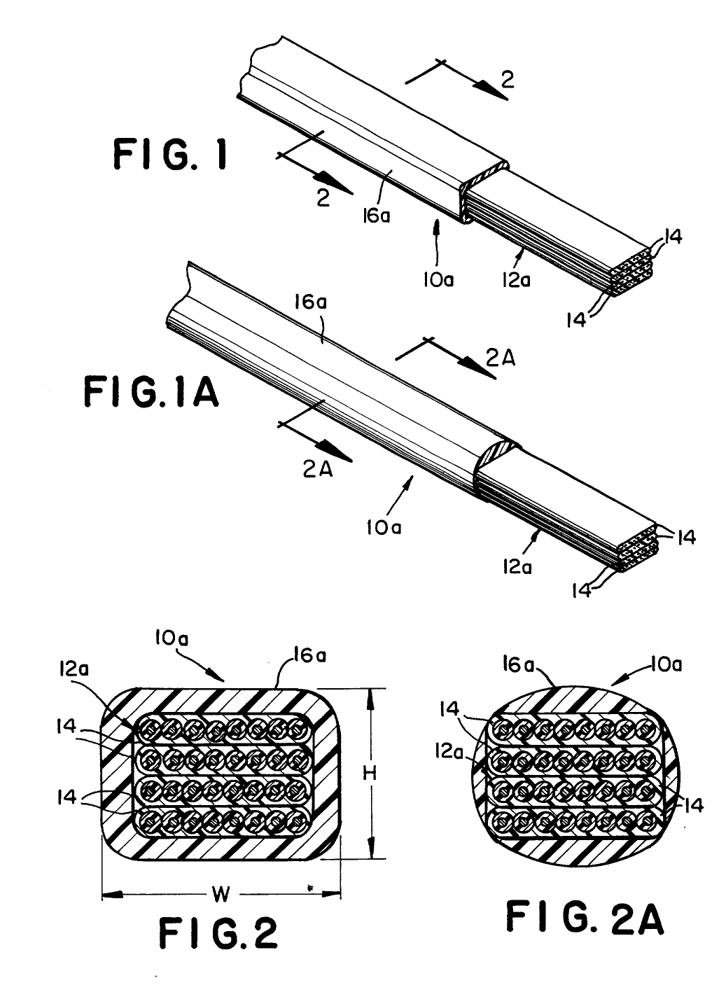

Having thus formed a stack of optical fiber ribbons, which may or may not be coated with core enclosures, this stack is then enclosed in a core enclosure. FIGS. 1 and 2 show a ribbon stack and core enclosure assembly 10a wherein optical fiber ribbons 14 in the form of a ribbon stack 12a are enclosed in a core enclosure 16a. Preferably, as shown in FIGS. 1 and 2, the stack of optical fiber ribbons and the core enclosure are both generally rectangular, but this is not required. Using a rectangular shape ensures a highly space-efficient use of the interior of the core enclosure and also, because the core enclosure preferably closely bounds the periphery of the stack, the core enclosure cushions all of the sides of the stack against mechanical impact or abrasion. It is preferred that the thickness of the core enclosure not exceed the thickness of the optical fiber ribbons so that the core enclosure may be easily removed and the optical fibers inside accessed.

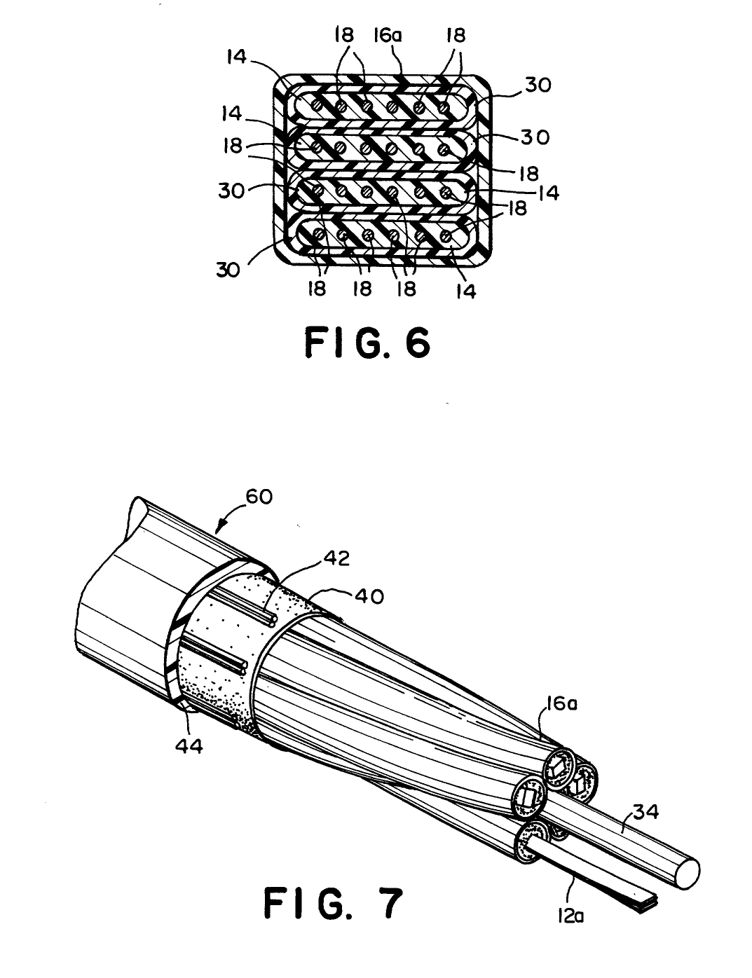

In an alternate embodiment, which is shown in FIG. 6, several optical fiber ribbons 14 are each enclosed in a core enclosure 30. The ribbons being enclosed in a core enclosure are then stacked upon each other and this stack of enclosed ribbons are enclosed in an outer core enclosure 16a.

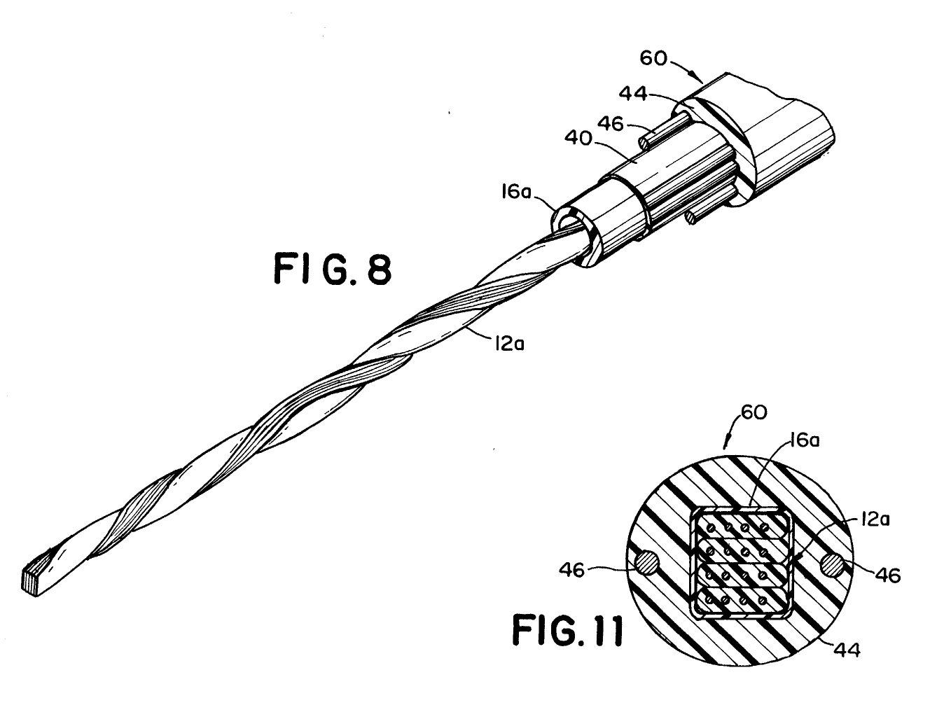

Once the core enclosure is constructed and enclosed around a bundle of optical fibers, the core enclosure can also be incorporated into a traditional fiber optic cable design, examples of which are shown in FIGS. 7 and 8 and described in greater detail below. Other optional components of a fiber optic cable include metallic shielding and polymeric coating layers, which provide additional protection against damage to the cable. The metallic shielding is particularly useful to protect against damage from lightening strikes, rodent bites and mechanical impacts. Also, water-absorbing and water-blocking yarns, tapes, fibers, gels, greases and pastes may optionally be included to supplement the water-absorbing and water-blocking capabilities of the core enclosure. The fiber optic cable may also include substantially incompressible strength members in order to provide tensile strength and preclude compressive (shrinkage) stresses applied to the plastic jacket from being transferred to the optical fibers within the ribbon stack. The strength members may be stainless steel wires, other high-strength metallic materials or nonmetals such as fiber glass, graphite, aramid yarn, or a ceramic fiber-reinforced polymer. Other components for use in fiber optic cables that are known to those skilled in the art may also be utilized.

Lastly, the fiber optic cable comprises an outer plastic jacket formed of polymeric materials such as polymers or copolymers of polyolefins or polyvinyls that are substantially fluid impervious or impermeable and enclose all of the components heretofore described.

When optical fibers are arranged as stacks of optical fiber ribbons, they will commonly be present in one of two different configurations generally referred to as “central-core” and “loose-tube” cables. Loose-tube fiber optic cables typically include a number of bundles or ribbons enclosed in a core enclosure or buffer tube that are positioned around a central strength member. FIG. 7 shows a loose-tube fiber optic cable prepared according to the present invention. In FIG. 7 a series of stacks of optical fiber ribbons 12a are enclosed in core enclosures 16a. The core enclosures are in turn helically wound around the central strength member 34 in a longitudinal direction as shown in FIG. 7. This loose-tube fiber optic cable also includes an inner jacket layer 40 made of a polymeric or metallic material. Additional strength members 42 located on the exterior of the inner jacket layer 40 provide the fiber optic cable with additional strength against bending or buckling in an unwanted direction. Lastly an outer plastic jacket 64 encloses all of these components. Loose-tube fiber optic cables are discussed in greater detail in U.S. Pat. No. 5,621,841.

In a central-core fiber optic cable 60 prepared according to the present invention (shown in FIG. 8) a stack of optical fiber ribbons 12a that are individually coated with core enclosures and/or enclosed within a core enclosure 16a, are located at the center of the fiber optic cable 60, while strength members 42 and other components are positioned between the core enclosure 16a and the outer plastic jacket 44 of the cable 60. The “central-core” configuration is discussed in greater detail in U.S. Pat. No. 4,078,853.

Another preferred configuration is the “slotted core fiber optic cable”. This cable comprises a central strength member, a plastic outer sleeving extruded around the central strength member, and a series of grooves or slots that are formed on the surface of the plastic sleeving, each groove containing an optical fiber. This “slotted-core” configuration is discussed in greater detail in U.S. Pat. No. 4,205,899, incorporated herein by reference. When this slotted core fiber optic cable design is utilized, the core enclosure can be extruded directly onto the plastic sleeving without the use of additional application of water-blocking components, such as water-absorbing and water-blocking fibers, tapes, gels or pastes.

The present core enclosures can be used in any of the cable configurations disclosed above and one of the advantages of the use of the present core enclosures is that fiber optic cable construction can be considerably simplified. Thus, while in most fiber optic cables the interior of the cable is densely packed with several layers of water-impervious polymer or metal jackets as well as water-absorbing greases, gels, tapes and yams, because of the superior efficiency of the present core enclosures at blocking water, these additional layers of water-blocking and water-absorbing materials are not necessary; although they may be optionally present. As mentioned above, because the gel and paste filling compounds are awkward and difficult to work with, avoiding the additional manufacturing step of inserting the filling compounds inside the core enclosures is a significant improvement over conventional fiber optic cable configurations as it not only saves time and reduces cost, but also facilitates the maintenance and installation of the cables in the field.

Accordingly, as can be seen in FIG. 11, a fiber optic cable 60 is shown wherein there is a considerable amount of space 55 between the core enclosure 16a and the outer jacket 44 that is open and free of any water-blocking or water-absorbing components. A pair of optional strength members 46 are also shown in FIG. 11 or they can be used alone as in FIGS. 9 and 10.

It should be noted that bonded arrays of optical fibers may be present in other shapes and configurations besides the optical fiber bundles and ribbons specifically discussed herein. Other shapes of bonded optical fiber arrays are discussed in greater detail in U.S. Pat. No. 4,900,126.

As noted above, lubricants may also be included in the core enclosures prepared according to the present invention. The lubricants may be applied directly to the interior surfaces of the core enclosure, or to the exterior surfaces of the optical fibers or bundles. The lubrication may also be applied to the exterior of the core enclosures when the core enclosures coat individual optical fiber ribbons which are then combined into a stack or when the core enclosures coat individual bundles of optical fiber ribbons which are then combined and further enclosed within a larger core enclosure as discussed above.

It is preferred that the applied lubricant not adversely interact with the optical fibers, the optical fiber polymeric matrix bonding material or the water-blocking mixture which forms the core enclosure. Particularly, the lubricant should not cause the core enclosure to swell excessively. Suitable lubricants include hydrocarbon oils and silicone fluids.

In one embodiment of the present invention, an electrostatically-charged powder lubricant is applied to the flat surfaces of optical fiber ribbons arranged in an optical fiber stack. These powders lubricate the individual fiber ribbons allowing them to move under service conditions, while their electrostatic charge assists in binding adjacent optical fiber ribbons into a stack. These electrostatically-charged powders can be water-absorbing, such as the superabsorbent polymers described above, but non water-absorbing powders are also contemplated.

The present invention also encompasses processes for making fiber optic bundles that are enclosed in core enclosures. Core enclosure fabrication is straightforward: the water-blocking core enclosure composition discussed in detail above is formed around an optical fiber bundle, the bundle having at least one optical fiber. One preferred method of forming the core enclosure around the optical fiber bundle is by extrusion. In the extrusion operation, bundles of optical fibers are drawn from spools under tension and through an extruder that extrudes the core enclosure composition over the bundle; this bundle may itself be in the form of a ribbon, a stack of ribbons or a polymer-coated bundle.

Alternatively, it is within the scope of this invention to extrude a core enclosure around a first optical fiber ribbon and then repeat the process by extruding a core enclosure around a second fiber ribbon, and then continually repeat this process multiple times until several core enclosure-enclosed optical fiber ribbons are produced; and then subsequently arranging these ribbons into the form of an optical fiber ribbon stack.

The core enclosure may also be formed on the bundle (which again may be in the form of a ribbon, a stack of ribbons or a polymer-coated bundle) by using various coating methods. For example, in a standard dip-coating operation the bundles can be drawn through a bath of the water-blocking core enclosure composition. Or rolls of the optical fibers can be unwound under tension, and drawn below a feed tank containing an atomized dispersion of the water-blocking core enclosure composition, which is deposited on the optical fiber bundles as they pass below the feed tank. The core enclosure coating can be heat cured at a temperature of from about 370° C. to 800° C., depending on the line speed-for example, at a line speed of about 30 meters per minute, the curing heat required would be about 630° C. using a 2 meter curing oven. The curing rate is a function of both time and temperature. It is necessary to avoid a curing rate that is either too fast or too slow. When the curing rate is too fast, the resulting material will be too soft because there is an insufficient amount of cross-linking between the polymer chains. A curing rate that is too slow not only produces a finished material that is too thick but also slows down the line speed of the coating operation that proceeds the curing step. One of ordinary skill in the art would understand that depending on the particularly application, the curing rate, the curing oven temperature, and the line speed could be varied, so long as the curing rate is not too fast or too slow.

Extrusion methods are particularly preferred for forming core enclosures over a stack of optical fiber ribbons. In a preferred embodiment of the invention, a collection of optical fiber ribbons are dispensed from multiple rotating spools and brought into close proximity to one another. The flat sides of the optical fiber ribbons, and/or the core enclosure which encloses the optical fiber ribbon are then preferably coated with a lubricant and ribbons are then brought together in a stack configuration and pressed together in a manner so that the surface tension of the lubricant adheres the ribbons together in a single stack unit. The stack may then be drawn through an extruder that extrudes a core enclosure over the stack. Methods for forming optical fiber ribbon stacks and extruding materials over such stacks are disclosed further in U.S. Pat. No. 5,621,841, and European Patent Application 0 996 015A1.

Dipping and coating methods are also discussed in greater detail in U.S. Pat. No. 5,817,713.

Lubricants may be applied to the bundle before or during the extrusion or coating processes discussed above. Alternatively, rather than directly applying an external lubricant, as the core enclosure is extruded onto the optical fiber bundle or bundles the plasticizer that is contained within the core enclosure composition provides lubrication after the core enclosure composition is heat molded around the bundles, ribbons or ribbon stack—as most plasiticizers are oil-based they are able to provide these lubrication benefits.

The invention will now be described in more detail with respect to the following specific, non-limiting examples:

### EXAMPLE I

Several core enclosure compositions were formulated as follows, wherein the amounts are in weight percentages:

TABLE I

| Composition | | | | PVC | PVC | PVC | PVC | PVC | SAP | SAP |
|---|---|---|---|---|---|---|---|---|---|---|
| No. | DOTP | TXIB | DOA | F-NV | F-24 | F-28 | 124 | 124A | 80HS | VG75-1 |
| 1 | | 40.3 | | | | | 12.7 | | 47 | |
| 2 | | 40.3 | | | | | | 12.7 | 47 | |
| 3 | | 37.3 | | | | | | 5.9 | 56.8 | |
| 4 | 37.3 | | | | | | | 5.9 | 56.8 | |
| 5 | 30 | 12.9 | | | | | | 14.3 | 42.9 | |
| 6 | 21.7 | 9.3 | | | | | | 24 | 45 | |
| 7 | 25 | 15 | | | | | | 20 | 40 | |
| 8 | 30 | 10 | | | | | | 20 | 40 | |
| 9 | 20 | 10 | | | | | | 30 | 40 | |
| 11 | 25 | 10 | | | | | | 25 | 40 | |
| 12 | 20 | 10 | | | | | | 30 | 40 | |
| 14 | | 25 | | 30 | | | | | 45 | |
| 15 | 30 | | | 25 | | | | | 45 | |
| 16 | 21.8 | 10.9 | | 22.8 | | | | | 44.6 | |
| 17A | 28 | 9 | | 8.5 | 12.5 | | | | 42 | |
| 17 | 28 | 9 | | 21 | | | | | 42 | |
| 18 | 30 | 10 | | 20 | | | | | 40 | |
| 19 | 27 | 8 | | 23 | | | | | 42 | |
| 20 | 25 | 5 | | 25 | | | | | 45 | |
| 21 | 25 | 10 | | 20 | | | | | 45 | |
| 22 | 25.6 | 11.7 | | 19.3 | | | | | 43.4 | |
| 23 | 13.2 | 18 | | 23.6 | | | | | 45.2 | |
| 25 | 20 | 10 | | 24 | | | | | 46 | |
| 26 | 17.4 | 8.7 | | 43.5 | | | | | 30.4 | |
| 27 | 20 | 10 | | | | 35 | | | 35 | |
| 28 | 28 | | 9 | 21 | | | | | 42 | |
| 29 | 27 | | 8 | 23 | | | | | 42 | |
| 30 | 25 | | 5 | 25 | | | | | 45 | |
| 31 | 20 | | 10 | 24 | | | | | 46 | |
| 32 | 26.4 | | 8.5 | 19.8 | | | | | 45.3 | |
| 34 | 18 | | 14 | 23 | | | | | 45 | |
| 37 | | | 32 | 23 | | | | | 45 | |
| 38 | | | 28.6 | 20.5 | | | | | 50.9 | |
| 40 | 12.5 | | 12.5 | 37.5 | | | | | | 37.5 |
| 41 | 16.9 | | 12.7 | 40.7 | | | | | | 29.7 |

DOTP, TXIB and DOA are the plasticizers dioctyl terephthalate, 2,2,4-trimethyl-1,3-pentanediol diisobutyrate, and dioctyl adipate, respectively.

PVC F-NV, PVC F-24, PVC F-28 are polyvinyl chloride thermoplastic materials from the Formosa Plastics Company. PVC 124 and PVC 124A are polyvinyl chloride thermoplastic materials from the Geon Company.

SAP 80 HS and SAP VG75-1 are superabsorbent polymers from The Stewart Group.

The compositions 1-41 were prepared as follows: the thermoplastic resin was dispersed into a liquid plasticizer in a high-shear crutcher or mixer (commonly known as a “dispersator”) to form a plastisol composition. Then SAP powder was mixed into the plastisol composition in a ribbon blender to form the core enclosure composition.

Having been so prepared, these core enclosure compositions were then formed as core enclosures around one or more optical fibers as follows.

Core enclosure compositions, which were prepared according to composition numbers 40 and 41, were each put into a screw-type extruder having four heating zones, each set at a temperature of 155° C. and operated at a speed of 70 RPM. The core enclosure compositions were then extruded over ten of the optical fibers, which were loosely packed together, through a round die and at a die temperature of 155° C. to form round tubular microsheath fiber optic cables. After exiting the extrusion die, the microsheath fiber optic cables were air-cooled, and required only 1.5 meters of space before being would-up into a take-up reel.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A core enclosure comprising a mixture of a superabsorbent polymer and a plastisol, the plastisol comprising a thermoplastic resin and a plasticizer, wherein the core enclosure has water-blocking capabilities.

2. The core enclosure according to claim 1, wherein the thermoplastic resin is selected from the group consisting of polyvinyl chloride, polyvinyl chloride copolymers, polyvinylidene chloride, polypropylene, polyethylene and mixtures thereof.

3. The core enclosure according to claim 1, wherein the plasticizer is selected from the group consisting of esters of phthalic acid, esters of adipic acid, esters of sebacic acid, phosphate esters, complex polymeric adipates, esters of isobutyric acid, and polyesters.

4. The core enclosure according to claim 3, wherein the core enclosure contains no more than about 50% of dioctyl terephthalate.

5. The core enclosure according to claim 3, wherein the core enclosure contains no more than about 50% of dioctyl adipate.

6. The core enclosure according to claim 4, wherein the plasticizer is selected from the group consisting of dioctyl-terephthalate, 2,2,4-trimethyl-1,3-pentanediol diisobutyrate, and mixtures thereof.

7. The core enclosure according to claim 6, wherein the core enclosure contains no more than about 50% of dicotyl-terephthalate, and no more than about 50% of 2,2,4-trimethyl-1,3-pentanediol diisobutyrate.

8. The core enclosure according to claim 1, wherein the plasticizer is selected from the group consisting of dioctyl-terephthalate, dioctyl adipate and mixtures thereof.

9. The core enclosure according to claim 1, wherein the plastisol further comprises an additive selected from the group consisting of secondary plasticizers, flame retardants, stabilizers, fillers, colorants, viscosity modifiers, foaming agents and combinations thereof.

10. The core enclosure according to claim 1, wherein the plastisol further comprises an additive selected from the group consisting of aliphatic and aromatic hydrocarbons, chlorinated hydrocarbons, epoxidized soya oils, linseed oils, and mixtures thereof.

11. The core enclosure according to claim 1, wherein the superabsorbent polymer is in particulate form.

12. The core enclosure according to claim 11, wherein the particulate superabsorbent polymer is selected from the group consisting of at least partially cross-linked polyacrylate homopolymers, copolymers of polyacrylate, and mixtures thereof.

13. The core enclosure according to claim 12, wherein the particulate superabsorbent polymer is a sodium polyacrylate homopolymer having an average particle size of from about 1 to about 500 microns.

14. The core enclosure according to claim 12, wherein the particulate superabsorbent polymer has an average particle size of from about 1 to about 100 microns.

15. The core enclosure according to claim 1, wherein the superabsorbent polymer is in the form of superabsorbent fibers.

16. The core enclosure according to claim 1, comprising: from about 10% to about 90% of the thermoplastic resin, from about 1% to about 60% of the superabsorbent polymer, and from about 10% to about 70% of the plasticizer.

17. The core enclosure according to claim 1, comprising: from about 10% to about 40% of the thermoplastic resin, from about 5% to about 55% of the superabsorbent polymer, and from about 20% to about 70% of the plasticizer.

18. A fiber optic cable comprising a fiber bundle having at least one optical fiber and a core enclosure disposed around the bundle, wherein the core enclosure comprises a water-blocking mixture of a superabsorbent polymer in a plastisol, and the plastisol comprises a thermoplastic resin and a plasticizer.

19. The fiber optic cable according to claim 18, wherein the bundle is coated with a layer, wherein the layer is comprised of the water-blocking mixture.

20. The fiber optic cable according to claim 18, wherein there is a plurality of the optical fibers arranged in the bundle and the interstices between adjacent optical fibers is filled by the water-blocking mixture.

21. The fiber optic cable according to claim 18, wherein there is a plurality of the optical fibers arranged in the bundle, and the bundle is enclosed within and adhered to the core enclosure.

22. The fiber optic cable according to claim 21, further comprising a strength member disposed within the space.

23. The fiber optic cable according to claim 22, further comprising an outersheath disposed around the stack.

24. The fiber optic cable according to claim 18, wherein there is a plurality of the optical fibers arranged in the bundle, and the bundle is capable of moving relative to the core enclosure.

25. The fiber optic cable according to claim 18, wherein the bundle is in the form of an optical fiber ribbon.

26. The fiber optic cable according to claim 18, further comprising a lubricant.

27. The fiber optic cable according to claim 18, further comprising a polymer jacket enclosing the core enclosure.

28. The fiber optic cable according to claim 22, wherein a space lies between the core enclosure and the jacket.

29. The fiber optic cable according to claim 28, further comprising a plurality of fiber bundles, each bundle having at least one optical fiber and wherein a core enclosure is disposed around each bundle.

30. The fiber optic cable according to claim 29, wherein each bundle is in the form of an optical fiber ribbon and the ribbons are arranged in a stack.

31. The fiber optic cable according to claim 29, wherein the plurality of fiber bundles are enclosed within a core enclosure.

32. The fiber optic cable according to claim 18, further comprising a plurality of fiber bundles, each bundle having at least one optical fiber and wherein the plurality of fiber bundles are enclosed within a core enclosure.

33. A method for manufacturing a fiber optic bundle enclosed in a core enclosure and comprising at least one optical fiber, comprising:
forming a core enclosure around the at least one optical fiber, wherein the core enclosure is formed from a water-blocking composition comprising a mixture of a superabsorbent polymer and a plastisol, the plastisol comprising a thermoplastic resin and a plasticizer.

34. The method according to claim 33, wherein the fiber optic bundle is in the form of a ribbon and is enclosed in a core enclosure.

35. The method according to claim 33, further comprising applying a lubricant to a surface of the bundle, optical fibers or core enclosure.

36. The method according to claim 33, wherein the core enclosure is formed by extrusion.

37. The method according to claim 36, wherein a lubricant is applied to the bundle during extrusion.

38. The method according to claim 33, wherein the core enclosure is formed by coating the optical fibers.

39. The method according to claim 33, further comprising repeating the method to form a plurality of the core enclosure-enclosed fiber optic bundles in the form of ribbons and arranging the ribbons in a stack.

40. A core enclosure comprising a mixture of a superabsorbent polymer, chlorinated hydrocarbons, and a plastisol, the plastisol comprising a thermoplastic resin and a plasticizer, wherein the core enclosure has water-blocking capabilities.
